(19) United States
(12) Patent Application Publication
(10) Pub. No.: US 2022/0000317 A1
(43) Pub. Date: Jan. 6, 2022

(54) Cooking Vessel Provided With A Cold Tubular Handle

(71) Applicant: SEB S.A., Ecully (FR)

(72) Inventor: Laurent Guegan, Lornay (FR)

(73) Assignee: SEB S.A., Ecully (FR)

(21) Appl. No.: 17/291,109

(22) PCT Filed: Nov. 22, 2019
(86) PCT No.: PCT/EP2019/082316

§ 371 Date: May 4, 2021

(30) Foreign Application Priority Data
Nov. 30, 2018 (FR) 1872135

(51) Int. Cl. A47J 45/08; A47J 45/06

(52) U.S. Cl. CPC A47J 45/08; A47J 45/061

(57) ABSTRACT

The invention relates to, a cooking vessel (1) intended to be placed on a heating source, said cooking vessel (1) comprising a side wall (4) and a handle (10) secured to said side wall (4) by fastening elements (15, 16), said handle (10) comprising a tubular gripping portion (11) which extends radially to the lateral wall (4) in a longitudinal direction X and which has an attachment end (12) and a free end (13) provided with an orifice (14). According to the invention, the attachment end (12) is closed by an end wall (4a) and the attachment end (12) comprises a closed bottom wall (17) and an upper wall (18) provided with at least one through opening (20) arranged adjacent to the side wall (4) so that rising hot currents which, during cooking, travel along the side wall (4), in the place where the handle (10) is attached create suction near the at least one opening (20) in order to generate an air flow front the orifice (14) to the inside of the tubular gripping portion (11) and thereby cool it.

The present invention relates to a cooking vessel intended for cooking food and which comprises a tubular handle, particularly a frying pan, a saucepan, or a sauteuse. Such a cooking vessel is intended to be placed on a heat source such as a gas stove.

Known from document EP0240225 is a handle intended to be secured to a side wall of a cooking vessel. The handle comprises an attachment part extended by a tubular gripping part that extends radially to the wall in a longitudinal direction and which has a free end provided with an orifice.

The tubular gripping part comprises an attachment end and the attachment end comprises a bottom wall provided with a first through opening and an upper wall provided with a second through opening. The first and second openings are arranged so as to be adjacent to the side wall. During cooking on a heat source, particularly a gas stove, the rising hot currents that travel along the side wall where the handle is attached pass through the first and second openings. A portion of these hot currents can be deviated after passing into the first opening to the interior of the tubular gripping part, going out again through the orifice of the free end.

Thus, the gripping zone can be heated during cooking and can reach an excessive temperature so that a user can grip it without means of protection, such as a glove.

The purpose of the present invention is to remedy the aforementioned disadvantages and to propose a cooking vessel provided with a tubular handle having a construction optimized to allow the user to manipulate it in complete safety, particularly at the level of the temperature of a gripping part of the tubular handle.

Another purpose of the invention is to propose a cooking vessel provided with a tubular handle of a design that is simple and economical to use.

These purposes are achieved with a cooking vessel intended to be placed on a source of heat, said cooking vessel comprising a side wall and a handle attached to said side wall by attachment members, said handle comprising a tubular gripping part that extends radially to the wall in a longitudinal direction and which has an attachment end and a free end provided with an orifice, characterized in that the attachment end is closed by an end wall and in that the attachment end comprises a closed bottom wall and an upper wall provided with at least one through opening arranged so as to be adjacent to the side wall so that rising hot currents that travel during cooking along the wall, at the place where the handle is attached, create a suction at the at least one opening in order to generate an airflow from the orifice towards the interior of the tubular gripping part and thereby cool it.

The temperature of the gripping part of the handle is therefore maintained at a sufficiently low level by the flow of fresh air that circulates in the tubular handle so that a user can grasp the gripping part without means of protection at any time during cooking.

Advantageously, the at least one opening extends in the longitudinal direction over at least 5 mm, preferably over at least 10 mm.

Thus, the at least one opening comprises two sides that extend along the longitudinal direction, each side creating a zone of release of the rising hot currents that travel during cooking along the side wall and around the attachment end of the tubular gripping part in order to generate a negative pressure above the through opening.

Advantageously, the handle comprises a vertical plane of symmetry that extends along the longitudinal direction. Thus, in the case where the upper wall is provided with only one through opening, this through opening extends on either side of the plane of symmetry.

Preferably, the at least one through opening has a surface area of more than 100 mm², preferably more than 200 mm².

Such a surface area enables the rising currents to create a suction at the at least one opening in order to generate sufficient airflow inside the tubular gripping part to cool it to an acceptable temperature level for gripping with the bare hand.

Advantageously, the at least one through opening is trapezoidal in shape, the base whereof forms an anterior part of the at least one through opening which is adjacent to the side wall.

Advantageously, the trapezoidal shape comprises a large base and a small base, the large base being adjacent to the side wall.

Preferably, the trapezoidal shape comprises two sides that extend along the longitudinal direction, each side creating a zone of release of the rising hot currents that travel during cooking along the side wall and around the attachment end of the tubular gripping part in order to generate a negative pressure above the through opening.

Advantageously, the end wall is formed by the side wall.

This arrangement makes it possible to obtain a handle using little material, and is therefore very economical.

Preferably, the attachment end comprises a collar that extends transversely to the longitudinal direction, the at least one through opening being arranged between the side wall and the collar in such a way that the rising hot currents are channeled toward the at least one through opening.

Thus, the rising currents create a stronger suction at the at least one opening, and therefore a greater airflow in the interior of the tubular gripping part in order better to cool it.

Advantageously, the collar extends over the entire periphery of the attachment end.

Preferably, the attachment members comprise two side tabs.

Advantageously, the tubular gripping part is produced from austenitic stainless steel.

The austenitic stainless steel has low thermal conductivity which makes it possible to slow the thermal flow by conduction toward the gripping part.

Preferably, the tubular gripping part has a thickness of less than 3 mm, preferably less than 2 mm.

This arrangement makes it possible to obtain a good compromise between the thinnest possible thickness for thermal reasons and sufficient thickness for good mechanical strength.

Preferably, the gripping part comprises only one through opening between the side wall on which the attachment end is attached and the orifice.

Advantageously, the cooking vessel is a frying pan, a saucepan, or a sauteuse.

The purposes, aspects and advantages of the present invention will be better understood from the description provided below of a particular embodiment of the invention provided by way of non-limiting example, with reference to the appended drawings in which:

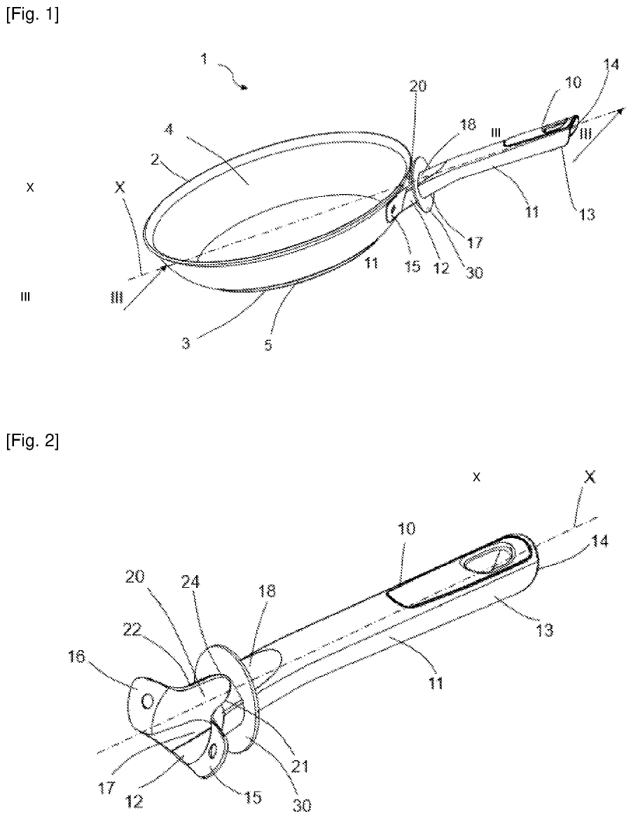

FIG. 1 illustrates a perspective view of a cooking vessel provided with a tubular handle according to a first particular embodiment of the invention,

FIG. 2 is a perspective view of the tubular handle depicted in FIG. 1,

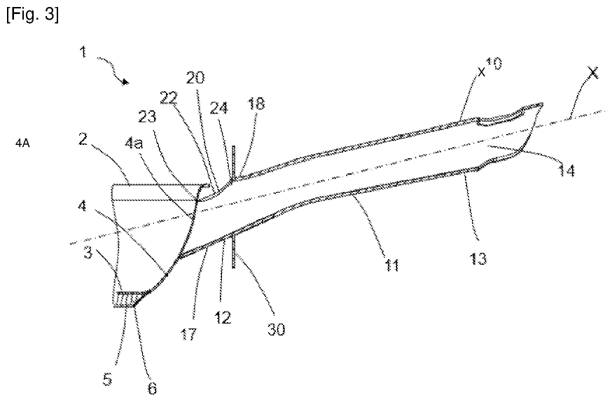

FIG. 3 is a view in cross-section along the plane III of the cooking vessel provided with the handle depicted in FIG. 1,

It will be noted that in this document, the terms “horizontal,” “vertical,” “lower,” “upper,” “longitudinal,” “transverse,” “top,” “bottom,” used to describe the cooking vessel provided with the handle, refer to the cooking vessel during use, when placed on a horizontal plane.

As can be seen in FIGS. 1 to 3, a cooking vessel 1 has a bowl 2 comprising a bottom 3 and a side wall 4. The bowl 2 is produced from stainless steel, for example by stamping a disk. The bottom 3 has a stainless-steel shield 5 that covers an aluminum portion 6 intended to distribute the heat (FIG. 3). The cooking vessel 1 is designed to ensure the cooking of various foods under the effect of an external source of heat. The cooking vessel 1 comprises a handle 10 arranged on the side wall 4. The cooking vessel 1 is therefore portable, in other words it can be moved manually.

The handle 10 comprises a tubular gripping part 11 that extends radially to the side wall 4 in a longitudinal direction X. The tubular gripping part 11 has an attachment end 12 and a free end 13 provided with an orifice 14. The tubular gripping part 11 has a substantially constant cross-section transverse to the longitudinal direction X. The orifice 14 has a surface area S1 equal to the transverse cross-section.

The attachment end 12 comprises two side tabs 15, 16 that form members for attachment to the side wall 4. The two side tabs 15, 16 extend transversely to the longitudinal direction X and are attached to the side wall 4 by riveting. The side wall 4 forms an end wall 4a which closes the attachment end 12.

The attachment end 12 comprises a closed bottom wall 17 and an upper wall 18 provided with a through opening 20 arranged so as to be adjacent to the side wall 4. The bottom wall 17 and the upper wall 18 respectively form half of the attachment end 12 of the tubular gripping part 11. The handle 10, particularly the attachment end 12, includes a vertical plane of symmetry in the longitudinal direction X. The through opening 20 has two sides 21, 22 that extend along the longitudinal direction X over 20 mm. The through opening 20 has an anterior part 23 closed by the side wall 4 and a rounded posterior part 24.

The through opening 20 extends on either side of the vertical plane of symmetry in the longitudinal direction X over an average distance Z equal to 10 mm. The through opening 20 has a surface area S2=X×Z equal to 200 mm².

Advantageously, the ratio of the surface area S1 of the orifice 14 to the surface area S2 of the through opening 20 is less than 1.2. In this embodiment, the ratio S2/S1 is equal to 1.

The handle 10, particularly the tubular gripping part 11, is produced from stainless steel sheet, preferably austenitic stainless steel. The handle 10 as well as the tubular gripping part 11 therefore has a substantially constant thickness equal to 1.2 mm.

During cooking, particularly on a gas stove, rising hot currents of air formed particularly by the combustion gases travel along the side wall 4, particularly at the attachment end 12 of the tubular gripping part 11. The flow of hot air currents creates an overpressure on the bottom wall 17 and a negative pressure on the upper wall 18 where the through opening 20 is positioned. Thus, an airflow is generated from the orifice 14 to the through opening 20, passing through the interior of the tubular gripping part 11. Because the air received at the orifice 14 is cooler, the tubular gripping part 11 is cooled.

There is a standard test imposing temperature limits not to be exceeded on the handle of a cooking vessel used on a gas stove.

For a metal handle, this limit is set at 55° C. according to a protocol detailed in standard EN 12983-1 (Annex F). Beyond this temperature of 55° C. the manufacturer must advise the user that thermal protective means such as a glove or potholder must be used to grasp the handle.

The Applicant has carried out temperature measurements at different measuring points on the tubular gripping part 11 of a frying pan 24 cm in diameter on a gas burner 7.5 cm in diameter. The frying pan is filled with 1.5 L of water and the gas flow rate is set at 185 L/h. Under these conditions, the temperatures are compared at a point corresponding to ⅓ the length of the handle, starting from the side wall, for a standard handle corresponding to the construction described in document EP0240225 and for an improved handle having the construction above. The improved handle 10 has a temperature 9° C. lower compared to the standard handle.

In one alternative embodiment, the attachment end 12 comprises a collar 30 that extends transversely to the longitudinal direction, in a substantially vertical plane. The through opening 20 is arranged on the upper wall 18 of the attachment end 12, between the side wall 4 and the collar 30. Thus, the rising hot currents that circulate along the sloped side wall 4 are concentrated toward the through opening 20.

Of course, the invention is in no way limited to the embodiments described and illustrated, which have only been provided by way of example. Changes can still be made, particularly with regard to the constitution of the various elements or by substituting technical equivalents, without departing from the scope of protection of the invention.

In one variant of embodiment, the end wall that closes the attachment end 12 forms part of the tubular gripping part 11. Thus, the connection zone between the end wall and the attachment end 12 does not include any leak.

1. A cooking vessel configured to be placed on a source of heat, said cooking vessel comprising:
a side wall and a handle attached to said side wall by attachment members, said handle comprising a tubular gripping part extending radially to the side wall in a longitudinal direction X and having an attachment end and a free end provided with an orifice,
wherein the attachment end is closed by an end wall, and
wherein the attachment end comprises a closed bottom wall and an upper wall provided with at least one through opening arranged so as to be adjacent to the side wall so that rising hot currents that travel during cooking along the side wall, at the place where the handle is attached, create a suction at the at least one opening to generate an airflow from the orifice towards the interior of the tubular gripping part and thereby cool it.

2. The cooking vessel according to claim 1, wherein the at least one through opening extends along the longitudinal direction X over at least 5 mm.

3. The cooking vessel according to claim 1, wherein the at least one through opening has a surface area of more than 100 mm², preferably more than 200 mm².

4. The cooking vessel according to claim 1, wherein at least one through opening is trapezoidal in shape, the base of the trapezoidal shape forming an anterior part of the at least one through opening adjacent to the sidewall.

5. The cooking vessel according to claim 4, wherein the trapezoidal shape comprises two sides extending along the longitudinal direction X, each side creating a zone of release of rising hot currents that travel during cooking along the side wall and around the attachment end of the tubular gripping part to generate a negative pressure above the through opening.

6. The cooking vessel according to claim 1, wherein the end wall is formed by the side wall.

7. The cooking vessel according to claim 1, wherein the attachment end comprises a collar extending transversely to the longitudinal direction X, the at least one through opening configured between the side wall and the collar so that the rising hot currents are channeled toward the at least one through opening.

8. The cooking vessel according to claim 7, wherein the collar extends over the full periphery of the attachment end.

9. The cooking vessel according to claim 8, wherein the attachment members comprise two side tabs.

10. The cooking vessel according to claim 1, wherein the tubular gripping part is produced from austenitic stainless steel.

11. The cooking vessel according to claim 10, wherein the tubular gripping part has a thickness of less than 3 mm.

12. The cooking vessel according to claim 1, wherein the tubular gripping part has only one through opening between the side wall on which the attachment end is attached and the orifice.

13. The cooking vessel according to claim 1, wherein the vessel is a frying pan, saucepan, or a sauteuse.

14. The cooking vessel according to claim 1, wherein the at least one through opening extends along the longitudinal direction X over at least 10 mm.

15. The cooking vessel according to claim 1, wherein the at least one through opening has a surface area of more than 200 mm².

16. The cooking vessel of claim 10, wherein the tubular gripping part has a thickness of less than 2 mm.
